(19) United States
(12) Patent Application Publication
(10) Pub. No.: US 2025/0380113 A1
(43) Pub. Date: Dec. 11, 2025

(54) METHODS AND APPARATUS FOR HANDLING DRX OPERATION FOR MBS MULTICAST RECEPTION IN WIRELESS COMMUNICATION SYSTEMS

(71) Applicant: Samsung Electronics Co., Ltd., Suwon-si, Gyeonggi-do (KR)

(72) Inventor: Vinay Kumar SHRIVASTAVA, Bangalore (IN)

(21) Appl. No.: 18/877,027

(22) PCT Filed: Jun. 27, 2023
(86) PCT No.: PCT/KR2023/008956

§ 371 Date: Dec. 19, 2024

(30) Foreign Application Priority Data
Jul. 6, 2022 (IN) 202241038940
Jun. 6, 2023 (IN) 2022 41038940

(51) Int. Cl. H04W 4/06; H04L 1/1812; H04W 52/02; H04W 72/23; H04W 76/27; H04W 76/28

(52) U.S. Cl. CPC H04W 4/06; H04L 1/1812; H04W 52/0216; H04W 72/23; H04W 76/27; H04W 76/28

(57) ABSTRACT

The disclosure relates to a 5G or 6G communication system for supporting a higher data transmission rate. Embodiments herein disclose methods and UE for handling DRX operation for MBS multicast reception in wireless network. Embodiments herein disclose methods for handling a DRX operation for MBS multicast reception in a wireless network (1000) by a UE (100). The method includes receiving the DRX configuration for at least one MRB for the multicast session reception to be received in a RRC inactive state. Further, the method includes detecting at least one event, where the UE is in the RRC inactive state. Further, the method includes handling the DRX operation for the multicast session reception in the RRC inactive state in the wireless network (1000) upon detecting the at least one event. The method can be used for handling the DRX operation for the MBS multicast reception in the RRC_INACTIVE state in the wireless network (1000) in an efficient, reliable and robust manner.

### TECHNICAL FIELD

Embodiments disclosed herein relate to wireless communication networks, and more particularly to systems and methods for Discontinuous Reception (DRX) mechanism for User Equipment (UEs) for New Radio Multicast Broadcast Service (NR MBS) in RRC_INACTIVE (RRC inactive) state.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

NR MBS services can refer to multicast services where intended common contents are targeted to a group of User Equipment's (UEs) which have joined a multicast group in a multicast coverage area and broadcast services where intended contents may be targeted to all the UEs in a broadcast coverage area. The multicast coverage area or the broadcast coverage area can be one radio cell or larger.

In a legacy system (i.e., Third Generation Partnership Project (3GPP) Release 17 MBS), the UE can receive broadcast services regardless of a RRC state of the UE. That is, the UE can avail broadcast service in all radio resource control (RRC) states viz. RRC_IDLE, RRC_INACTIVE and RRC_CONNECTED. Also, in the 3GPP Release 17 MBS, multicast service is limited to be accessible only in the RRC_CONNECTED state due to reliability constraints.

However, 3GPP Release 18 MBS is considering to extend the accessibility of the multicast services also to the UEs in the RRC_INACTIVE state, so that more UEs can access the multicast services as well as the limitation of the number of active connections in the RRC_CONNECTED can be overcome. Further, in the legacy system, a DRX configuration and mechanism for the multicast services, which is designed for operation in the RRC_CONNECTED state only, needs to be revisited for potential changes to work in the RRC_INACTIVE state.

Presently there is no existing configuration and mechanism for the UEs to avail the multicast services in the RRC_INACTIVE state. Many of the procedures that are used in the RRC_CONNECTED state; e.g., Channel Status Information (CSI) reporting, Sounding Reference Signal (SRS) transmission, Hybrid automatic repeat request (HARQ) retransmission and HARQ feedback, may not be directly workable in the RRC_INACTIVE state. Further, the UE may undergo transitions across the RRC states, and DRX configurations and signaling may need to be modified.

Hence, it is desired to address the above mentioned disadvantages or other short comings or at least provide a useful alternative.

### DISCLOSURE OF INVENTION

### Technical Problem

The principal object of the embodiments herein is to disclose a method and a UE for handling a NR MBS, where a DRX mechanism for the UEs is provided that may receive multicast service in a RRC_INACTIVE state and provides solutions and approaches to achieve efficient, reliable and robust DRX mechanism.

Another object of the embodiments herein is to handle the DRX configuration and operation for the UE to receive the multicast service in a RRC_INACTIVE state and enables efficient power saving of the UE.

Another object of the embodiments herein is to provide an efficient and effective DRX configuration and operation to support multicast reception continuity in a RRC INACTIVE state.

The present invention has been made to address at least the above problems and/or disadvantages and to provide at least the advantages described below. Accordingly, an aspect of the present invention provides a method and apparatus for handling DRX operation for MBS multicast reception in wireless communication systems.

### Solution to Problem

Accordingly, the embodiments herein provide methods for handling a DRX operation for a MBS multicast reception in a wireless network. The method includes receiving, by a UE, a DRX configuration for at least one multicast radio bearer (MRB) for a multicast session reception to be received in a RRC inactive state. Further, the method includes detecting, by a UE, at least one event, where the UE is in the RRC inactive state. Further, the method includes handling, by the UE, the DRX operation for the multicast session reception in the RRC inactive state in the wireless network upon detecting the at least one event.

In an embodiment, further, the method includes at least one of configuring, by the UE, the DRX configuration for at least one multicast MBS radio bearer (MRB) for the multicast session reception in the RRC inactive state, modifying, by the UE, the DRX configuration for at least one multicast MBS radio bearer (MRB) for the multicast session reception in the RRC inactive state, and, releasing, by the UE, the DRX configuration for at least one multicast MBS radio bearer (MRB) for the multicast session reception in the RRC inactive state.

In an embodiment, the DRX configuration for the at least one multicast MRB for the multicast session reception in the RRC inactive state is released when the UE initiates at least one of a RRC connection resumption procedure and a RRC reestablishment procedure.

In an embodiment, the DRX configuration for the at least one multicast MRB for the multicast session reception in the RRC inactive state is released when the UE performs at least one of a cell reselection, a cell reselection to a different cell than a cell that configured the DRX configuration, and a cell reselection to a different cell that is outside a coverage of the multicast service reception in the RRC inactive state.

In an embodiment, the DRX configuration for the at least one multicast MRB for the multicast session reception in the RRC inactive state is released when the UE (100) is not configured for the pertinent multicast session reception in the RRC inactive state.

In an embodiment, the DRX configuration used for the multicast session reception in the RRC inactive state is at least one of configuration which the UE has stored previously or is a configuration stored in a UE inactive Access Stratum (AS) context or is provided to the UE by a RRC Release with suspend configuration message or a multicast MBS Control Channel (MCCH) message.

In an embodiment, handling, by the UE, the DRX operation for the multicast session reception in the RRC inactive state upon detecting the at least one event includes stopping, by the UE, at least one of a drx-RetransmissionTimerDL-PTM and a drx-HARQ-RTT-TimerDL-PTM in the RRC inactive state upon detecting the at least one event corresponds to not enabling or allowing the UE to receive retransmission for a multicast service packet reception.

In an embodiment, handling, by the UE, the DRX operation for the multicast session reception in the RRC inactive state upon detecting the at least one event includes continuing, by the UE, at least one of a drx-onDurationTimerPTM and a drx-InactivityTimerPTM timer upon detecting that the UE transitions from a RRC connected state to the RRC inactive state when a multicast session is in an activated state and a multicast DRX is configured.

In an embodiment, handling, by the UE, the DRX operation for the multicast session reception in the RRC inactive state upon detecting the at least one event includes stopping, by the UE, at least one of a drx-onDurationTimerPTM and a drx-InactivityTimerPTM timer, upon detecting that the UE transitions from a RRC connected state to the RRC inactive state when a multicast session is in a deactivated state and a multicast DRX is configured.

In an embodiment, handling, by the UE, the DRX operation for the multicast session reception in the RRC inactive state upon detecting the at least one event includes stopping, by the UE, at least one of a drx-RetransmissionTimerDL-PTM and a drx-HARQ-RTT-TimerDL-PTM upon detecting the UE transitions from a RRC connected state to the RRC inactive state.

In an embodiment, handling, by the UE, the DRX operation for the multicast session reception in the RRC inactive state upon detecting the at least one event includes determining, by the UE, an Active Time for multicast DRX in the RRC inactive state, when a multicast DRX is configured for at least one of a Group Radio Network Temporary Identifier (G-RNTI) and a Group Configured Scheduling Radio Network Temporary Identifier (G-CS-RNTI) when the UE is in the RRC inactive state and multicast session is activated, while at least one of a drx-onDurationTimerPTM and a drx-InactivityTimerPTM for at least one of the G-RNTI and the G-CS-RNTI is running.

In an embodiment, handling, by the UE, the DRX operation for the multicast session reception in the RRC inactive state upon detecting the at least one event includes stopping, by the UE, at least one configured DRX timer, when a multicast session for a TMGI (Temporary Mobile Group Identity) or a MBS session identity is configured, and the multicast session is not in an activated state.

In an embodiment, handling, by the UE, the DRX operation for the multicast session reception in the RRC inactive state upon detecting the at least one event includes starting, by the UE, at least one configured DRX timer, when a multicast session for a TMGI is configured, and the multicast session is activated upon a group notification reception where the group notification reception is provided by a group paging message or a multicast MCCH message, and applying, by the UE, the DRX configuration.

In an embodiment, handling, by the UE, the DRX operation for the multicast session reception in the RRC inactive state upon detecting the at least one event includes operating, by the UE, at least one configured DRX timer, when a multicast session for a TMGI is configured, and the multicast session is in an activated state, stopping, by the UE, the at least one configured DRX timer, when the multicast session for the TMGI is configured, and the multicast session is deactivated upon a group notification reception, where the group notification reception is provided by a group paging message or a multicast MCCH message, and storing, by the UE, the DRX configuration.

In an embodiment, handling, by the UE, the DRX operation for the multicast session reception upon detecting the at least one event includes operating, by the UE, at least one configured DRX timer, when the multicast session for the TMGI that is configured and the multicast session is in an activated state, stopping, by the UE, the at least one configured DRX timer, when the multicast session for the TMGI that is configured and the multicast session is released upon a group notification reception, where the group notification reception is provided by a group paging message or a multicast MCCH message, and releasing, by the UE, the DRX configuration.

In an embodiment, the multicast session in the activated state is notified using at least one of a group paging, a broadcast signaling and a multicast MBS Control Channel (MCCH) change notification, where the broadcast signaling includes a SIB or a multicast MCCH message.

In an embodiment, handling, by the UE, the DRX operation for the multicast session reception upon detecting the at least one event includes operating, by the UE, at least one of a drx-RetransmissionTimerDL-PTM and a drx-HARQ-RTT-TimerDL-PTM upon receiving a retransmission for a multicast service packet when the UE is receiving the multicast session in the RRC inactive state.

In an embodiment, handling, by the UE, the DRX operation for the multicast session reception upon detecting the at least one event includes considering, by the UE, a hybrid automatic repeat request (HARQ) feedback condition as invalid, upon determining that UE is receiving the multicast session in the RRC inactive state and does not provide HARQ feedback for a MBS Medium Access Control Protocol Data Unit (MAC PDU).

In an embodiment, handling, by the UE, the DRX operation for the multicast session reception upon detecting the at least one event includes ignoring, by the UE, a downlink control information (DCI) field that indicates a value of a HARQ feedback upon determining that the UE is receiving the multicast session in the RRC inactive state.

In an embodiment, handling, by the UE, the DRX operation for the multicast session reception upon detecting the at least one event includes considering, by the UE, at least one of a drx-RetransmissionTimerDL-PTM and a drx-HARQ-RTT-TimerDL-PTM in a DRX configuration as invalid in a RRC inactive state.

In an embodiment, handling, by the UE, the DRX operation for the multicast session reception upon detecting the at least one event includes removing, by the UE, a drx-RetransmissionTimerDL-PTM and drx-HARQ-RTT-TimerDL-PTM from a DRX configuration upon detecting that the UE transitions from a RRC connected state to the RRC inactive state.

In an embodiment, the at least one event includes corresponds at least one of: not enabling or allowing UE to receive retransmission for a multicast service packet reception, the UE transitions from a RRC connected state to the RRC inactive state when a multicast session is in an activated state and a multicast DRX is configured, the UE transitions from the RRC connected state to the RRC inactive state when the multicast session is in a deactivated state and the multicast DRX is configured, the UE transitions from the RRC connected state to the RRC inactive state, the UE is in the RRC inactive state and the multicast session is activated, while at least one of a drx-onDurationTimerPTM and a drx-InactivityTimerPTM for at least one of a G-RNTI and a G-CS-RNTI is running, when a multicast session for a TMGI is configured, and the multicast session is activated upon a group notification reception, the multicast session for a TMGI is configured, and a multicast session is not in an activated state, the multicast session for the TMGI that is configured, and the multicast session is in an activated state, retransmission for a multicast service packet when the UE is receiving the multicast session in the RRC inactive state, the UE receiving the multicast session in the RRC inactive state and does not provide HARQ feedback for a MBS MAC PDU, and the UE is receiving the multicast session in the RRC inactive state.

Accordingly, the embodiments herein provide a UE including a DRX operation controller coupled with a processor and a memory. The DRX operation controller is configured to receive a DRX configuration for at least one MRB for a multicast session reception to be received in a RRC inactive state. Further, the DRX operation controller is configured to detect at least one event, where the UE is in a RRC inactive state. Further, the DRX operation controller is configured to handle the DRX operation for at least one multicast session reception service in the RRC inactive state in the wireless network upon detecting the at least one event.

In an embodiment, the DRX operation controller is configured to release the DRX configuration for at least one multicast MRB for the multicast session reception in the RRC inactive state.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

### Advantageous Effects of Invention

Advantages, and salient features of the invention will become apparent to those skilled in the art from the following detailed description, which, taken in conjunction with the annexed drawings, discloses exemplary embodiments of the invention. For more enhanced communication system, there is a need for method and apparatus for handling DRX operation for MBS multicast reception in wireless communication systems.

### BRIEF DESCRIPTION OF DRAWINGS

The embodiments disclosed herein are illustrated in the accompanying drawings, throughout which like reference letters indicate corresponding parts in the various figures. The embodiments herein will be better understood from the following description with reference to the drawings, in which:

FIG. 1 illustrates a wireless network for handling a DRX operation for MBS multicast reception, according to the embodiments as disclosed herein;

FIG. 2 shows various hardware components of a UE, according to the embodiments as disclosed herein;

FIG. 3 is a flow chart illustrating a method, implemented by the UE, for handling the DRX operation for the MBS multicast reception in the wireless network, according to the embodiments as disclosed herein;

FIG. 4A illustrates an operational flow of a DRX operation for the UE configured and/or receiving multicast in a RRC_INACTIVE state, according to embodiments as disclosed herein;

FIG. 4B illustrates an operational flow of a DRX operation for the UE configured and/or receiving multicast in a RRC_INACTIVE state, according to embodiments as disclosed herein;

FIG. 5A illustrates an operational flow of the DRX operation for the UE configured and/or receiving multicast in the RRC_INACTIVE state, according to embodiments as disclosed herein;

FIG. 5B illustrates an operational flow of the DRX operation for the UE configured and/or receiving multicast in the RRC_INACTIVE state, according to embodiments as disclosed herein;

FIG. 6 illustrates the structure of the UE to which embodiments of the disclosure can be applied; and

FIG. 7 illustrates a block diagram of a TRP in a wireless communication system to which embodiments of the disclosure can be applied.

### MODE FOR THE INVENTION

NR MBS services can refer to multicast services where intended common contents are targeted to a group of User Equipment's (UEs) which have joined a multicast group in a multicast coverage area and broadcast services where intended contents may be targeted to all the UEs in a broadcast coverage area. The multicast coverage area or the broadcast coverage area can be one radio cell or larger.

In a legacy system (i.e., Third Generation Partnership Project (3GPP) Release 17 MBS), the UE can receive broadcast services regardless of a RRC state of the UE. That is, the UE can avail broadcast service in all radio resource control (RRC) states viz. RRC_IDLE, RRC_INACTIVE and RRC_CONNECTED. Also, in the 3GPP Release 17 MBS, multicast service is limited to be accessible only in the RRC_CONNECTED state due to reliability constraints.

However, 3GPP Release 18 MBS is considering to extend the accessibility of the multicast services also to the UEs in the RRC_INACTIVE state, so that more UEs can access the multicast services as well as the limitation of the number of active connections in the RRC_CONNECTED can be overcome. Further, in the legacy system, a DRX configuration and mechanism for the multicast services, which is designed for operation in the RRC_CONNECTED state only, needs to be revisited for potential changes to work in the RRC_INACTIVE state.

Presently there is no existing configuration and mechanism for the UEs to avail the multicast services in the RRC_INACTIVE state. Many of the procedures that are used in the RRC_CONNECTED state; e.g., Channel Status Information (CSI) reporting, Sounding Reference Signal (SRS) transmission, Hybrid automatic repeat request (HARQ) retransmission and HARQ feedback, may not be directly workable in the RRC_INACTIVE state. Further, the UE may undergo transitions across the RRC states, and DRX configurations and signaling may need to be modified.

Hence, it is desired to address the above mentioned disadvantages or other short comings or at least provide a useful alternative.

Accordingly, the embodiments herein provide methods for handling a DRX operation for a MBS multicast reception in a wireless network. The method includes receiving, by a UE, a DRX configuration for at least one multicast radio bearer (MRB) for a multicast session reception to be received in a RRC inactive state. Further, the method includes detecting, by a UE, at least one event, where the UE is in the RRC inactive state. Further, the method includes handling, by the UE, the DRX operation for the multicast session reception in the RRC inactive state in the wireless network upon detecting the at least one event.

In an embodiment, further, the method includes at least one of configuring, by the UE, the DRX configuration for at least one multicast MBS radio bearer (MRB) for the multicast session reception in the RRC inactive state, modifying, by the UE, the DRX configuration for at least one multicast MBS radio bearer (MRB) for the multicast session reception in the RRC inactive state, and, releasing, by the UE, the DRX configuration for at least one multicast MBS radio bearer (MRB) for the multicast session reception in the RRC inactive state.

In an embodiment, the DRX configuration for the at least one multicast MRB for the multicast session reception in the RRC inactive state is released when the UE initiates at least one of a RRC connection resumption procedure and a RRC reestablishment procedure.

In an embodiment, the DRX configuration for the at least one multicast MRB for the multicast session reception in the RRC inactive state is released when the UE performs at least one of a cell reselection, a cell reselection to a different cell than a cell that configured the DRX configuration, and a cell reselection to a different cell that is outside a coverage of the multicast service reception in the RRC inactive state.

In an embodiment, the DRX configuration for the at least one multicast MRB for the multicast session reception in the RRC inactive state is released when the UE (100) is not configured for the pertinent multicast session reception in the RRC inactive state.

In an embodiment, the DRX configuration used for the multicast session reception in the RRC inactive state is at least one of configuration which the UE has stored previously or is a configuration stored in a UE inactive Access Stratum (AS) context or is provided to the UE by a RRC Release with suspend configuration message or a multicast MBS Control Channel (MCCH) message.

In an embodiment, handling, by the UE, the DRX operation for the multicast session reception in the RRC inactive state upon detecting the at least one event includes stopping, by the UE, at least one of a drx-RetransmissionTimerDL-PTM and a drx-HARQ-RTT-TimerDL-PTM in the RRC inactive state upon detecting the at least one event corresponds to not enabling or allowing the UE to receive retransmission for a multicast service packet reception.

In an embodiment, handling, by the UE, the DRX operation for the multicast session reception in the RRC inactive state upon detecting the at least one event includes continuing, by the UE, at least one of a drx-onDurationTimerPTM and a drx-InactivityTimerPTM timer upon detecting that the UE transitions from a RRC connected state to the RRC inactive state when a multicast session is in an activated state and a multicast DRX is configured.

In an embodiment, handling, by the UE, the DRX operation for the multicast session reception in the RRC inactive state upon detecting the at least one event includes stopping, by the UE, at least one of a drx-onDurationTimerPTM and a drx-InactivityTimerPTM timer, upon detecting that the UE transitions from a RRC connected state to the RRC inactive state when a multicast session is in a deactivated state and a multicast DRX is configured.

In an embodiment, handling, by the UE, the DRX operation for the multicast session reception in the RRC inactive state upon detecting the at least one event includes stopping, by the UE, at least one of a drx-RetransmissionTimerDL-PTM and a drx-HARQ-RTT-TimerDL-PTM upon detecting the UE transitions from a RRC connected state to the RRC inactive state.

In an embodiment, handling, by the UE, the DRX operation for the multicast session reception in the RRC inactive state upon detecting the at least one event includes determining, by the UE, an Active Time for multicast DRX in the RRC inactive state, when a multicast DRX is configured for at least one of a Group Radio Network Temporary Identifier (G-RNTI) and a Group Configured Scheduling Radio Network Temporary Identifier (G-CS-RNTI) when the UE is in the RRC inactive state and multicast session is activated, while at least one of a drx-onDurationTimerPTM and a drx-InactivityTimerPTM for at least one of the G-RNTI and the G-CS-RNTI is running.

In an embodiment, handling, by the UE, the DRX operation for the multicast session reception in the RRC inactive state upon detecting the at least one event includes stopping, by the UE, at least one configured DRX timer, when a multicast session for a TMGI (Temporary Mobile Group Identity) or a MBS session identity is configured, and the multicast session is not in an activated state.

In an embodiment, handling, by the UE, the DRX operation for the multicast session reception in the RRC inactive state upon detecting the at least one event includes starting, by the UE, at least one configured DRX timer, when a multicast session for a TMGI is configured, and the multicast session is activated upon a group notification reception where the group notification reception is provided by a group paging message or a multicast MCCH message, and applying, by the UE, the DRX configuration.

In an embodiment, handling, by the UE, the DRX operation for the multicast session reception in the RRC inactive state upon detecting the at least one event includes operating, by the UE, at least one configured DRX timer, when a multicast session for a TMGI is configured, and the multicast session is in an activated state, stopping, by the UE, the at least one configured DRX timer, when the multicast session for the TMGI is configured, and the multicast session is deactivated upon a group notification reception, where the group notification reception is provided by a group paging message or a multicast MCCH message, and storing, by the UE, the DRX configuration.

In an embodiment, handling, by the UE, the DRX operation for the multicast session reception upon detecting the at least one event includes operating, by the UE, at least one configured DRX timer, when the multicast session for the TMGI that is configured and the multicast session is in an activated state, stopping, by the UE, the at least one configured DRX timer, when the multicast session for the TMGI that is configured and the multicast session is released upon a group notification reception, where the group notification reception is provided by a group paging message or a multicast MCCH message, and releasing, by the UE, the DRX configuration.

In an embodiment, the multicast session in the activated state is notified using at least one of a group paging, a broadcast signaling and a multicast MBS Control Channel (MCCH) change notification, where the broadcast signaling includes a SIB or a multicast MCCH message.

In an embodiment, handling, by the UE, the DRX operation for the multicast session reception upon detecting the at least one event includes operating, by the UE, at least one of a drx-RetransmissionTimerDL-PTM and a drx-HARQ-RTT-TimerDL-PTM upon receiving a retransmission for a multicast service packet when the UE is receiving the multicast session in the RRC inactive state.

In an embodiment, handling, by the UE, the DRX operation for the multicast session reception upon detecting the at least one event includes considering, by the UE, a hybrid automatic repeat request (HARQ) feedback condition as invalid, upon determining that UE is receiving the multicast session in the RRC inactive state and does not provide HARQ feedback for a MBS Medium Access Control Protocol Data Unit (MAC PDU).

In an embodiment, handling, by the UE, the DRX operation for the multicast session reception upon detecting the at least one event includes ignoring, by the UE, a downlink control information (DCI) field that indicates a value of a HARQ feedback upon determining that the UE is receiving the multicast session in the RRC inactive state.

In an embodiment, handling, by the UE, the DRX operation for the multicast session reception upon detecting the at least one event includes considering, by the UE, at least one of a drx-RetransmissionTimerDL-PTM and a drx-HARQ-RTT-TimerDL-PTM in a DRX configuration as invalid in a RRC inactive state.

In an embodiment, handling, by the UE, the DRX operation for the multicast session reception upon detecting the at least one event includes removing, by the UE, a drx-RetransmissionTimerDL-PTM and drx-HARQ-RTT-TimerDL-PTM from a DRX configuration upon detecting that the UE transitions from a RRC connected state to the RRC inactive state.

In an embodiment, the at least one event includes corresponds at least one of: not enabling or allowing UE to receive retransmission for a multicast service packet reception, the UE transitions from a RRC connected state to the RRC inactive state when a multicast session is in an activated state and a multicast DRX is configured, the UE transitions from the RRC connected state to the RRC inactive state when the multicast session is in a deactivated state and the multicast DRX is configured, the UE transitions from the RRC connected state to the RRC inactive state, the UE is in the RRC inactive state and the multicast session is activated, while at least one of a drx-onDurationTimerPTM and a drx-InactivityTimerPTM for at least one of a G-RNTI and a G-CS-RNTI is running, when a multicast session for a TMGI is configured, and the multicast session is activated upon a group notification reception, the multicast session for a TMGI is configured, and a multicast session is not in an activated state, the multicast session for the TMGI that is configured, and the multicast session is in an activated state, retransmission for a multicast service packet when the UE is receiving the multicast session in the RRC inactive state, the UE receiving the multicast session in the RRC inactive state and does not provide HARQ feedback for a MBS MAC PDU, and the UE is receiving the multicast session in the RRC inactive state.

Accordingly, the embodiments herein provide a UE including a DRX operation controller coupled with a processor and a memory. The DRX operation controller is configured to receive a DRX configuration for at least one MRB for a multicast session reception to be received in a RRC inactive state. Further, the DRX operation controller is configured to detect at least one event, where the UE is in a RRC inactive state. Further, the DRX operation controller is configured to handle the DRX operation for at least one multicast session reception service in the RRC inactive state in the wireless network upon detecting the at least one event.

In an embodiment, the DRX operation controller is configured to release the DRX configuration for at least one multicast MRB for the multicast session reception in the RRC inactive state.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

In the invention description, the terms multicast, multicast reception, multicast session and multicast service may have been used interchangeably and should be considered without the loss of generality or specificity.

The embodiments herein achieve a method for handling a DRX operation for MBS multicast reception in a wireless network. The method includes receiving, by a UE, a DRX configuration for at least one MRB for a multicast session reception to be received in a RRC inactive state. Further, the method includes detecting, by a UE, at least one event, where the UE is in the RRC inactive state. Further, the method includes handling, by the UE, the DRX operation for the multicast session reception in the RRC inactive state in the wireless network upon detecting the at least one event.

The method can be used for handling the DRX operation for the MBS multicast reception in the RRC_INACTIVE state in the wireless network in an efficient, reliable and robust manner.

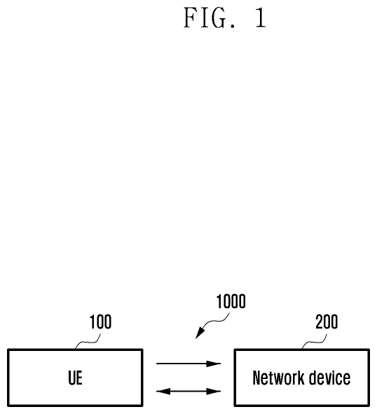

Referring now to the drawings, and more particularly to FIGS. 1 through 5, where similar reference characters denote corresponding features consistently throughout the figures, there are shown at least one embodiment.

FIG. 1 illustrates a wireless network (1000) for handling a DRX operation for MBS multicast reception in RRC_INACTIVE state, according to the embodiments as disclosed herein. In an embodiment, the wireless network (1000) includes a UE (100) and a network device (200). The wireless network (1000) can be, for example, but not limited to a fourth generation (4G) network, a fifth generation (5G) network, a sixth generation (6G) network an Open Radio Access Network (ORAN) or the like.

The UE (100) can be, for example, but not limited to a laptop, a smart phone, a desktop computer, a notebook, a Device-to-Device (D2D) device, a vehicle to everything (V2X) device, a foldable phone, a smart TV, a tablet, an immersive device, and an internet of things (IoT) device. The network device (200) can be, for example, but not limited to a gNB, a eNB, a NR trans-receiver or the like.

The UE (100) receives a DRX configuration for a MRB for a multicast session reception to be received in a RRC inactive state. Further, the UE (100) detects an event, where the UE (100) is in the RRC inactive state. The event corresponds at least one of: not enabling or allowing the UE (100) to receive retransmission for a multicast service packet reception, the UE (100) transitions from a RRC connected state to the RRC inactive state when a multicast session is in an activated state and a multicast DRX is configured, the UE (100) transitions from the RRC connected state to the RRC inactive state when the multicast session is in a deactivated state and the multicast DRX is configured, the UE (100) transitions from the RRC connected state to the RRC inactive state, the UE (100) is in the RRC inactive state and the multicast session is activated, while at least one of a drx-onDurationTimerPTM and a drx-Inactivity TimerPTM for at least one of a G-RNTI and a G-CS-RNTI is running, when a multicast session for a TMGI is configured, and the multicast session is activated upon a group notification reception, the multicast session for a TMGI is configured, and a multicast session is not in an activated state, the multicast session for the TMGI that is configured, and the multicast session is in an activated state, retransmission for a multicast service packet when the UE (100) is receiving the multicast session in the RRC inactive state, the UE (100) receiving the multicast session in the RRC inactive state and does not provide HARQ feedback for a MBS MAC PDU, and the UE (100) is receiving the multicast session in the RRC inactive state.

Upon detecting the event, the UE (100) handles the DRX operation for the multicast session reception in the RRC inactive state in the wireless network (1000).

In an embodiment, the UE (100) that is receiving the multicast service in the RRC_INACTIVE state does not receive retransmissions for the multicast services packet (i.e., a MAC PDU). For this reason, the UE (100) does not operate drx-RetransmissionTimerDL-PTM and drx-HARQ-RTT-TimerDL-PTM in the RRC_INACTIVE state.

In an embodiment, when the UE (100) transitions from a RRC_CONNECTED to the RRC_INACTIVE and if the multicast session is in the activated state and if the multicast DRX is configured, the UE (100) continues a drx-onDurationTimerPTM and/or a drx-InactivityTimerPTM timer. That is, the drx-onDurationTimerPTM and/or the drx-InactivityTimerPTM timers are not stopped and continued with their existing timer running values.

In an embodiment, when the UE (100) transitions from the RRC_CONNECTED to the RRC_INACTIVE and if the multicast session is in the deactivated state and if the multicast DRX is configured, the UE (100) does not operate the drx-onDurationTimerPTM and/or the drx-InactivityTimerPTM timers. This implies that there is no periodical starting/restarting of the drx-onDurationTimerPTM timer in the RRC_INACTIVE when multicast session is in the deactivated state. In other words, a MAC entity of the UE (100) starts drx-onDurationTimerPTM after drx-SlotOffsetPTM from the beginning of the subframe, if the multicast session is activated (i.e., not deactivated).

In an embodiment, when the UE (100) transitions from the RRC_CONNECTED to the RRC_INACTIVE, a drx-RetransmissionTimerDL-PTM and/or a drx-HARQ-RTT-TimerDL-PTM are stopped. That is, the drx-RetransmissionTimerDL-PTM and/or the drx-HARQ-RTT-TimerDL-PTM are not operated in the RRC_INACTIVE.

In an embodiment, when the UE (100) transitions from the RRC_CONNECTED to the RRC_INACTIVE, a different or modified configuration (e.g. a timer value) is applied for at least one DRX timer for multicast session reception in the RRC inactive state, wherein the DRX timer may comprise of at least one of drx-onDurationTimerPTM, the drx-InactivityTimerPTM, drx-RetransmissionTimerDL-PTM and a drx-HARQ-RTT-TimerDL-PTM.

In an embodiment, when the UE (100) transitions from the RRC_CONNECTED to the RRC_INACTIVE, the existing DRX configuration for the multicast MRB is released and a new DRX configuration for the multicast MRB is applied for the multicast session reception in the RRC inactive state. Further, the multicast MRB that is used for the multicast session reception in the RRC_CONNECTED is released and a multicast MRB is newly established for the multicast reception in the RRC_INACTIVE or the multicast MRB is re-established for the multicast reception in the RRC_INACTIVE.

In an embodiment, when the UE (100) transitions from the RRC_INACTIVE to the RRC_CONNECTED, the drx-RetransmissionTimerDL-PTM and/or the drx-HARQ-RTT-TimerDL-PTM are started. That is, the drx-RetransmissionTimerDL-PTM and/or the drx-HARQ-RTT-TimerDL-PTM are operated in the RRC_CONNECTED state. This may also be in accordance with the new DRX configuration received by the UE (100) in the RRC_CONNECTED and the UE (100) operates drx-RetransmissionTimerDL-PTM and/or drx-HARQ-RTT-TimerDL-PTM timers as per new configuration.

In an embodiment, when the multicast DRX is configured for a G-RNTI or a G-CS-RNTI and the UE (100) is in the RRC_CONNECTED, an Active Time includes the time while drx-onDurationTimerPTM or drx-InactivityTimerPTM or drx-RetransmissionTimerDL-PTM for the G-RNTI or the G-CS-RNTI is running.

In an embodiment, when the multicast DRX is configured for the G-RNTI or the G-CS-RNTI and the UE (100) is in the RRC_INACTIVE and the multicast session is activated, the active time includes the time while the drx-onDurationTimerPTM or the drx-InactivityTimerPTM for the G-RNTI or G-CS-RNTI is running.

In an embodiment, if the multicast session for the TMGI (addressed by G-RNTI or G-CS-RNTI) which is configured but is not in the activated state (i.e., multicast session is deactivated) in the RRC_INACTIVE, the UE (100) does not operate the configured DRX timers. That is, the UE (100) remains in the DRX sleep (i.e., not in Active Time) for the multicast session. The DRX configuration can be at least one of configuration which the UE (100) has stored previously (e.g., from RRC reconfiguration message) or is stored in the UE (100) inactive Access Stratum (AS) context or is provided to the UE (100) by the RRC Release with suspend configuration (e.g., for multicast reception in RRC_INACTIVE (referred to herein as mbs-multicast-InactiveConfig). The DRX timers which are not operated or not started includes at least one of drx-onDurationTimerPTM, drx-InactivityTimerPTM, drx-RetransmissionTimerDL-PTM and drx-HARQ-RTT-TimerDL-PTM.

In an embodiment, if the multicast session for the TMGI (addressed by the G-RNTI or the G-CS-RNTI) which is configured and is also in the activated state in the RRC_INACTIVE or is activated (e.g., as notified in the group paging or broadcast signalling like SIB or multicast MCCH message or multicast MCCH change notification for the “activation” of the multicast session for the TMGI), the UE (100) operates the configured DRX timers. The utilized DRX configuration can be at least one of configuration which the UE (100) has stored previously (e.g., from RRC reconfiguration message) or is stored in the inactive AS context of the UE or is provided to the UE (100) by the RRC Release with suspend configuration (e.g., for multicast reception in RRC_INACTIVE).

In an embodiment, if the multicast session for the TMGI (addressed by the G-RNTI or the G-CS-RNTI) which is configured and is in the activated state in the RRC_INACTIVE, is now deactivated (e.g., as notified in the group paging or broadcast signalling like SIB or multicast MCCH message or multicast MCCH change notification for the “deactivation” of the multicast session for the TMGI), the UE (100) stops operating the configured DRX timers. The DRX timers, if already running, are stopped/reset. The UE (100) remains in the DRX sleep i.e., not in Active Time for the multicast session for the TMGI. The UE (100) retains or stores the DRX configuration. The DRX configuration can be at least one of configuration which the UE (100) has stored previously (e.g., from RRC reconfiguration message) or is stored in the inactive AS context of the UE (100) or is provided to the UE (100) by the RRC Release with suspend configuration (e.g., for multicast reception in RRC_INACTIVE).

In an embodiment, if the multicast session for the TMGI (addressed by the G-RNTI or the G-CS-RNTI) which is configured and is in the activated state in the RRC_INACTIVE, is now released (e.g., as notified in group paging or broadcast signalling like SIB or multicast MCCH message or multicast MCCH change notification for the “release” of the multicast session for the TMGI), the UE (100) stops operating the configured DRX timers. Further, the UE (100) releases the DRX configuration. The DRX configuration released can be at least one of configuration which the UE (100) has stored previously (e.g., from the RRC reconfiguration message) or is stored in the inactive AS context of the UE (100) or is provided to the UE (100) by the RRC Release with suspend configuration (e.g., for multicast reception in RRC_INACTIVE).

### Discontinuous Reception (DRX) for MBS Multicast

For the MBS multicast, the MAC entity may be configured by the RRC with the DRX functionality per G-RNTI or per G-CS-RNTI that controls the UE's PDCCH monitoring activity for the MAC entity's G-RNTI(s) and G-CS-RNTI(s) as specified in TS 38.331. When in the RRC_CONNECTED or in the RRC_INACTIVE, if the multicast DRX is configured, and the multicast session is activated, the MAC entity is allowed to monitor the PDCCH for the G-RNTI or the G-CS-RNTI discontinuously using the multicast DRX operation specified in this clause; otherwise, the MAC entity monitors the PDCCH for the G-RNTI or the G-CS-RNTI as specified in TS 38.213. The multicast DRX operation specified in the clause is performed independently for each G-RNTI or G-CS-RNTI and independently from the DRX operation specified in clauses 5.7 and 5.7a of the 3GPP NR MAC specification (38.321).

The RRC controls the multicast DRX operation per G-RNTI or per G-CS-RNTI by configuring the following parameters:
a) drx-onDurationTimerPTM: the duration at the beginning of a DRX cycle;
b) drx-SlotOffsetPTM: the delay before starting the drx-onDurationTimerPTM;
c) drx-InactivityTimerPTM: the duration after the PDCCH occasion in which a PDCCH indicates a new DL multicast transmission for the MAC entity;
d) drx-LongCycleStartOffsetPTM: a long DRX cycle drx-LongCycle-PTM and drx-StartOffset-PTM which defines the subframe where the long DRX cycle starts;
e) drx-RetransmissionTimerDL-PTM (per DL HARQ process for MBS multicast): the maximum duration until a DL multicast retransmission is received; and
f) drx-HARQ-RTT-TimerDL-PTM (per DL HARQ process for MBS multicast): the minimum duration before a DL multicast assignment for HARQ retransmission is expected by the MAC entity.

When the multicast DRX is configured for the G-RNTI or the G-CS-RNTI and the UE (100) is in the RRC_CONNECTED, the Active Time includes the time while:
a) drx-onDurationTimerPTM or drx-InactivityTimerPTM or drx-RetransmissionTimerDL-PTM for the G-RNTI or the G-CS-RNTI is running.

When the multicast DRX is configured for the G-RNTI or the G-CS-RNTI and the UE (100) is in the RRC_INACTIVE and the multicast session is activated, the active time includes the time while:
a.drx-onDurationTimerPTM or drx-InactivityTimerPTM for the G-RNTI or G-CS-RNTI is running.

When the UE (100) transitions from the RRC_CONNECTED to the RRC_INACTIVE, the drx-RetransmissionTimerDL-PTM and the drx-HARQ-RTT-TimerDL-PTM are stopped. That is, the drx-RetransmissionTimerDL-PTM and the drx-HARQ-RTT-TimerDL-PTM are not operated in the RRC_INACTIVE.

When the UE (100) transitions from the RRC_INACTIVE to the RRC_CONNECTED, the drx-RetransmissionTimerDL-PTM and the drx-HARQ-RTT-TimerDL-PTM are started. That is, the drx-RetransmissionTimerDL-PTM and drx-HARQ-RTT-TimerDL-PTM are operated in the RRC_CONNECTED.

When the UE (100) transitions from the RRC_CONNECTED to the RRC_INACTIVE, the drx-onDurationTimerPTM and the drx-InactivityTimerPTM are continued. That is, the drx-RetransmissionTimerDL-PTM and drx-HARQ-RTT-TimerDL-PTM are not operated in RRC_INACTIVE.

When the UE (100) transitions from the RRC_INACTIVE to the RRC_CONNECTED, the drx-onDurationTimerPTM and the drx-InactivityTimerPTM are continued. That is, the drx-RetransmissionTimerDL-PTM and the drx-HARQ-RTT-TimerDL-PTM are operated in the RRC_CONNECTED.

When the multicast DRX is configured for the G-RNTI or the G-CS-RNTI, the MAC entity shall for the G-RNTI or the G-CS-RNTI:
1> if the MAC PDU is received in a configured downlink multicast assignment and the UE (100) is in the RRC_CONNECTED:
   2> if the HARQ feedback is enabled:
      3> start the drx-HARQ-RTT-TimerDL-PTM for the corresponding HARQ process in a first symbol after the end of the corresponding transmission carrying the DL HARQ feedback;
      3> start the drx-HARQ-RTT-TimerDL for the corresponding HARQ process in the first symbol after the end of the corresponding transmission carrying the DL HARQ feedback;
   2> stop the drx-RetransmissionTimerDL-PTM for the corresponding HARQ process;
   2> stop the drx-RetransmissionTimerDL for the corresponding HARQ process.
1> if a drx-HARQ-RTT-TimerDL-PTM expires:
   2> if the data of the corresponding HARQ process was not successfully decoded:
      3> start the drx-RetransmissionTimerDL-PTM for the corresponding HARQ process in the first symbol after the expiry of drx-HARQ-RTT-TimerDL-PTM.
1> if a DRX Command MAC CE with DCI scrambled with a G-RNTI is received:
   2> stop drx-onDurationTimerPTM of the DRX for the G-RNTI;
   2> stop drx-InactivityTimerPTM of the DRX for the G-RNTI.
1> if [(SFN X 10)+subframe number] modulo (drx-LongCycle-PTM)=drx-StartOffset-PTM:
   2> start drx-onDurationTimerPTM after drx-SlotOffsetPTM from the beginning of the subframe, if the multicast session is activated (i.e., not deactivated).
1> if the MAC entity is in Active Time for the G-RNTI or G-CS-RNTI:
   2> monitor the PDCCH for the G-RNTI or G-CS-RNTI as specified in TS 38.213;
   2> if the PDCCH indicates a DL multicast transmission and the UE (100) is in the RRC_CONNECTED:
      3> if HARQ feedback is enabled:
         4> start the drx-HARQ-RTT-TimerDL-PTM for the corresponding HARQ process in the first symbol after the end of the corresponding transmission carrying the DL HARQ feedback;
         4> start the drx-HARQ-RTT-TimerDL for the corresponding HARQ process in the first symbol after the end of the corresponding transmission carrying the DL HARQ feedback;
      3> stop the drx-RetransmissionTimerDL-PTM for the corresponding HARQ process;
      3> stop the drx-RetransmissionTimerDL for the corresponding HARQ process.
   2> if the multicast session is activated and the PDCCH indicates a new multicast transmission for the G-RNTI or G-CS-RNTI:
      3> start or restart drx-InactivityTimerPTM in the first symbol after the end of the PDCCH reception.

The PDCCH indicating activation of multicast SPS is considered to indicate a new transmission.

In an embodiment, the MAC entity need not monitor the PDCCH for the G-RNTI or the G-CS-RNTI if it is not a complete PDCCH occasion (e.g., the Active Time for the G-RNTI or the G-CS-RNTI starts or ends in the middle of the PDCCH occasion).

In an embodiment, the UE (100) that is receiving multicast service in the RRC_INACTIVE state may receive retransmissions for the multicast services packet (i.e., a MAC PDU). For this purpose, the UE (100) operates the drx-RetransmissionTimerDL-PTM and the drx-HARQ-RTT-TimerDL-PTM in the RRC_INACTIVE state.

In an embodiment, when the UE (100) transitions from the RRC_CONNECTED to the RRC_INACTIVE, the drx-RetransmissionTimerDL-PTM and the drx-HARQ-RTT-TimerDL-PTM are not stopped. That is, the drx-Re-transmissionTimerDL-PTM and the drx-HARQ-RTT-TimerDL-PTM are continued in the RRC_INACTIVE.

In an embodiment, when the UE (100) transitions from the RRC_INACTIVE to the RRC_CONNECTED, the drx-RetransmissionTimerDL-PTM and the drx-HARQ-RTT-TimerDL-PTM are not started/restarted. That is, the drx-RetransmissionTimerDL-PTM and the drx-HARQ-RTT-TimerDL-PTM are continued in the RRC_CONNECTED.

In an embodiment, when the UE (100) transitions from the RRC_CONNECTED to the RRC_INACTIVE, the drx-onDurationTimerPTM and the drx-InactivityTimerPTM are continued. Further, the drx-RetransmissionTimerDL-PTM and the drx-HARQ-RTT-TimerDL-PTM are not operated in the RRC_INACTIVE.

In an embodiment, when the UE (100) transitions from the RRC_INACTIVE to the RRC_CONNECTED, the drx-onDurationTimerPTM and the drx-InactivityTimerPTM are continued. Further, the drx-RetransmissionTimerDL-PTM and the drx-HARQ-RTT-TimerDL-PTM are operated in the RRC_CONNECTED.

In an embodiment, when the UE (100) transitions from the RRC_CONNECTED to the RRC_INACTIVE, the drx-onDurationTimerPTM and the drx-InactivityTimerPTM are restarted (or stopped and started). Further, the drx-RetransmissionTimerDL-PTM and the drx-HARQ-RTT-TimerDL-PTM are not operated in the RRC_INACTIVE.

In an embodiment, when the UE (100) transitions from the RRC_INACTIVE to the RRC_CONNECTED, the drx-onDurationTimerPTM and the drx-InactivityTimerPTM are restarted (or stopped and started). Further, the drx-RetransmissionTimerDL-PTM and the drx-HARQ-RTT-TimerDL-PTM are operated in the RRC_CONNECTED.

### Discontinuous Reception (DRX) for MBS Multicast

For the MBS multicast, the MAC entity may be configured by RRC with a DRX functionality per G-RNTI or per G-CS-RNTI that controls the UE's PDCCH monitoring activity for the MAC entity's G-RNTI(s) and G-CS-RNTI(s) as specified in TS 38.331. When in the RRC_CONNECTED or in the RRC_INACTIVE, if the multicast DRX is configured, and the multicast session is activated, the MAC entity is allowed to monitor the PDCCH for the G-RNTI or G-CS-RNTI discontinuously using the multicast DRX operation specified in this clause; otherwise, the MAC entity monitors the PDCCH for the G-RNTI or G-CS-RNTI as specified in TS 38.213. The multicast DRX operation specified in the clause is performed independently for each G-RNTI or G-CS-RNTI and independently from the DRX operation specified in clauses 5.7 and 5.7a.

The RRC controls multicast DRX operation per G-RNTI or per G-CS-RNTI by configuring the following parameters:
a) drx-onDurationTimerPTM: the duration at the beginning of a DRX cycle;
b) drx-SlotOffsetPTM: the delay before starting the drx-onDurationTimerPTM;
c) drx-InactivityTimerPTM: the duration after the PDCCH occasion in which a PDCCH indicates a new DL multicast transmission for the MAC entity;
d) drx-LongCycleStartOffsetPTM: the long DRX cycle drx-LongCycle-PTM and drx-StartOffset-PTM which defines the subframe where the long DRX cycle starts;
e) drx-RetransmissionTimerDL-PTM (per DL HARQ process for MBS multicast): the maximum duration until a DL multicast retransmission is received; and
f) drx-HARQ-RTT-TimerDL-PTM (per DL HARQ process for MBS multicast): the minimum duration before a DL multicast assignment for HARQ retransmission is expected by the MAC entity.

When the multicast DRX is configured for the G-RNTI or the G-CS-RNTI, the Active Time includes the time while:
a) The drx-onDurationTimerPTM or the drx-InactivityTimerPTM or the drx-RetransmissionTimerDL-PTM for the G-RNTI or the G-CS-RNTI is running.

When the UE (100) transitions from the RRC_CONNECTED to the RRC_INACTIVE, the drx-RetransmissionTimerDL-PTM and the drx-HARQ-RTT-TimerDL-PTM are not stopped. That is, the drx-Re-transmissionTimerDL-PTM and the drx-HARQ-RTT-TimerDL-PTM are continued in RRC_INACTIVE.

When the UE (100) transitions from the RRC_INACTIVE to the RRC_CONNECTED, the drx-RetransmissionTimerDL-PTM and the drx-HARQ-RTT-TimerDL-PTM are not started/restarted. That is, the drx-RetransmissionTimerDL-PTM and the drx-HARQ-RTT-TimerDL-PTM are continued in the RRC_CONNECTED.

When the UE (100) transitions from the RRC_CONNECTED to the RRC_INACTIVE, the drx-onDurationTimerPTM and the drx-InactivityTimerPTM are continued. Further, the drx-RetransmissionTimerDL-PTM and the drx-HARQ-RTT-TimerDL-PTM are not operated in the RRC_INACTIVE.

When the UE (100) transitions from the RRC_INACTIVE to the RRC_CONNECTED, the drx-onDurationTimerPTM and the drx-InactivityTimerPTM are continued. Further, the drx-RetransmissionTimerDL-PTM and the drx-HARQ-RTT-TimerDL-PTM are operated in the RRC_CONNECTED.

When the multicast DRX is configured for the G-RNTI or G-CS-RNTI, the MAC entity shall for the G-RNTI or the G-CS-RNTI:
1> if the MAC PDU is received in the configured downlink multicast assignment and the UE (100) is in the RRC_CONNECTED:
   2> if the HARQ feedback is enabled:
      3> start the drx-HARQ-RTT-TimerDL-PTM for the corresponding HARQ process in the first symbol after the end of the corresponding transmission carrying the DL HARQ feedback;
      3> start the drx-HARQ-RTT-TimerDL for the corresponding HARQ process in the first symbol after the end of the corresponding transmission carrying the DL HARQ feedback;
   2> stop the drx-RetransmissionTimerDL-PTM for the corresponding HARQ process;
   2> stop the drx-RetransmissionTimerDL for the corresponding HARQ process.
1> if a MAC PDU is received in a configured downlink multicast assignment and the UE (100) is in RRC_INACTIVE:
   2> start the drx-HARQ-RTT-TimerDL-PTM for the corresponding HARQ process in the first symbol after the end of the corresponding supposedly transmission carrying the DL HARQ feedback;
   2> stop the drx-RetransmissionTimerDL-PTM for the corresponding HARQ process;
1> if a drx-HARQ-RTT-TimerDL-PTM expires:
   2> if the data of the corresponding HARQ process was not successfully decoded:
      3> start the drx-RetransmissionTimerDL-PTM for the corresponding HARQ process in the first symbol after the expiry of drx-HARQ-RTT-TimerDL-PTM.
1> if a DRX Command MAC CE with DCI scrambled with a G-RNTI is received:
   2> stop drx-onDurationTimerPTM of the DRX for the G-RNTI;
   2> stop drx-InactivityTimerPTM of the DRX for the G-RNTI.
1> if [(SFN X 10)+subframe number] modulo (drx-LongCycle-PTM) =drx-StartOffset-PTM:
   2> start drx-onDurationTimerPTM after drx-SlotOffsetPTM from the beginning of the subframe, if the multicast session is activated (i.e., not deactivated).
1> if the MAC entity is in Active Time for the G-RNTI or G-CS-RNTI:
   2> monitor the PDCCH for the G-RNTI or G-CS-RNTI as specified in TS 38.213;
   2> if the PDCCH indicates a DL multicast transmission and the UE (100) is in the RRC_CONNECTED:
      3> if HARQ feedback is enabled:
         4> start the drx-HARQ-RTT-TimerDL-PTM for the corresponding HARQ process in the first symbol after the end of the corresponding transmission carrying the DL HARQ feedback;
         4> start the drx-HARQ-RTT-TimerDL for the corresponding HARQ process in the first symbol after the end of the corresponding transmission carrying the DL HARQ feedback;
      3> stop the drx-RetransmissionTimerDL-PTM for the corresponding HARQ process;
      3> stop the drx-RetransmissionTimerDL for the corresponding HARQ process.
   2> if the PDCCH indicates a DL multicast transmission and the UE (100) is in the RRC_INACTIVE:
      3> start the drx-HARQ-RTT-TimerDL-PTM for the corresponding HARQ process in the first symbol after the end of the corresponding supposedly transmission carrying the DL HARQ feedback;
      3> stop the drx-RetransmissionTimerDL-PTM for the corresponding HARQ process.
   2> if the multicast session is activated and the PDCCH indicates a new multicast transmission for the G-RNTI or G-CS-RNTI:
      3> start or restart drx-InactivityTimerPTM in the first symbol after the end of the PDCCH reception.

The PDCCH indicating activation of multicast SPS is considered to indicate a new transmission.

The MAC entity needs not monitor the PDCCH for the G-RNTI or the G-CS-RNTI if it is not the complete PDCCH occasion (e.g., the Active Time for the G-RNTI or the G-CS-RNTI starts or ends in the middle of the PDCCH occasion).

In an embodiment, the UE (100) that is receiving the multicast service in the RRC_INACTIVE state does not provide HARQ feedback for the MBS MAC PDU received. For this purpose, “HARQFeedback” condition is specified or considered as FALSE or INVALID, when the UE is receiving multicast in the RRC_INACTIVE state.

In an embodiment, the UE (100) that is receiving multicast service in the RRC_INACTIVE state ignores the DCI field that indicates “HARQFeedback” as enabled or disabled value. For example, if the multicast scheduling DCI format 4_1 or DCI format 4_2 or like carries the field for HARQFeedback enabled or disabled, the UE (100) in the RRC_INACTIVE state does not read or ignore or does not consider the field.

In an embodiment, the UE (100) that is receiving the multicast service in the RRC_INACTIVE state does not receive retransmissions for the multicast services packet (i.e., a MAC PDU). For this purpose, the DRX configuration for the multicast bearer for pertinent multicast service UE (100) does not include drx-RetransmissionTimerDL-PTM and drx-HARQ-RTT-TimerDL-PTM for the multicast reception in the RRC_INACTIVE state. In another embodiment, the UE (100) considers the drx-RetransmissionTimerDL-PTM and the drx-HARQ-RTT-TimerDL-PTM in the configuration as invalid or not applicable in the RRC_INACTIVE state.

In an embodiment, the UE (100) that is receiving the multicast service in the RRC_INACTIVE state may receive retransmissions for the multicast services packet (i.e., a MAC PDU), if there are HARQ retransmission received as long as the UE (100) is in the Active Time and the UE (100) could not decode the previous transmission of multicast packets. This may be in spite of drx-RetransmissionTimerDL-PTM and drx-HARQ-RTT-TimerDL-PTM are not configured for the RRC_INACTIVE UEs.

In an embodiment, when the UE (100) transitions from the RRC_CONNECTED to the RRC_INACTIVE, drx-RetransmissionTimerDL-PTM and drx-HARQ-RTT-TimerDL-PTM are not included or removed from the DRX configuration. The network device (200) may also provide a new DRX configuration to the UE (100). In another embodiment, when the UE (100) transitions from the RRC_CONNECTED to the RRC_INACTIVE, the UE (100) considers drx-RetransmissionTimerDL-PTM and drx-HARQ-RTT-TimerDL-PTM in the configuration as invalid or not applicable in the RRC_INACTIVE state.

In an embodiment, when the UE (100) transitions from the RRC_INACTIVE to the RRC_CONNECTED, the drx-RetransmissionTimerDL-PTM and the drx-HARQ-RTT-TimerDL-PTM are included or added from the DRX configuration. The network device (200) may also provide the new DRX configuration to the UE (100) (e.g., through dedicated signaling like RRC reconfiguration message or RRC resume message or RRC setup message). In another embodiment, when the UE (100) transitions from the RRC_INACTIVE to the RRC_CONNECTED, the UE (100) considers drx-RetransmissionTimerDL-PTM and drx-HARQ-RTT-TimerDL-PTM in the configuration as valid or applicable in the RRC_CONNECTED state.

DRX-Config-PTM information element

| | |
|---|---|
| DRX-ConfigPTM-r17 ::= | SEQUENCE { |
| drx-onDurationTimerPTM-r17 | CHOICE { |
| subMilliSeconds | INTEGER (1..31), |
| milliSeconds | ENUMERATED { |

```
                  ms1, ms2, ms3, ms4, ms5, ms6, ms8, ms10, ms20, ms30, ms40, ms50, ms60, ms80, ms100, ms200, ms300,
ms400, ms500, ms600, ms800, ms1000, ms1200, ms1600, spare8, spare7, spare6, spare5, spare4, spare3, spare2, spare1
          }
    },
```

| | |
|---|---|
| drx-InactivityTimerPTM-r17 | ENUMERATED { |

```
              ms0, ms1, ms2, ms3, ms4, ms5, ms6, ms8, ms10, ms20, ms30, ms40, ms50, ms60, ms80, ms100, ms200, ms300,
ms500, ms750, ms1280, ms1920, ms2560, spare9, spare8, spare7, spare6, spare5, spare4, spare3, spare2, spare1
      },
```

| | | |
|---|---|---|
| drx-HARQ-RTT-TimerDL-PTM-r17 | INTEGER (0..56) | OPTIONAL, -- Cond |

HARQFeedback

| | |
|---|---|
| drx-RetransmissionTimerDL-PTM-r17 ENUMERATED { | sl0, sl1, sl2, sl4, sl6, sl8, sl16, sl24, sl33, sl40, sl64, |

sl80, sl96, sl112, sl128, sl160, sl320, spare15, spare14, spare13, spare12, spare11, spare10, spare9, spare8, spare7, spare6, spare5,
spare4, spare3, spare2, spare1

| | |
|---|---|
| } | OPTIONAL, -- Cond HARQFeedback |

| | |
|---|---|
| drx-LongCycleStartOffsetPTM-r17 | CHOICE { |
| ms10 | INTEGER(0..9), |
| ms20 | INTEGER(0..19), |
| ms32 | INTEGER(0..31), |
| ms40 | INTEGER(0..39), |
| ms60 | INTEGER(0..59), |
| ms64 | INTEGER(0..63), |
| ms70 | INTEGER(0..69), |
| ms80 | INTEGER(0..79), |
| ms128 | INTEGER(0..127), |
| ms160 | INTEGER(0..159), |
| ms256 | INTEGER(0..255), |
| ms320 | INTEGER(0..319), |
| ms512 | INTEGER(0..511), |
| ms640 | INTEGER(0..639), |
| ms1024 | INTEGER(0..1023), |
| ms1280 | INTEGER(0..1279), |
| ms2048 | INTEGER(0..2047), |
| ms2560 | INTEGER(0..2559), |
| ms5120 | INTEGER(0..5119), |
| ms10240 | INTEGER(0..10239) |

},

| | |
|---|---|
| drx-SlotOffsetPTM-r17 | INTEGER (0..31) |

```
  }
  -- TAG-DRX-CONFIGPTM-STOP
  -- ASN1STOP
```

DRX-Config-PTM field descriptions

drx-HARQ-RTT-Timer-DL-PTM
Value in number of symbols of the CFR where the transport block
was received.
drx-InactivityTimerPTM
Value in multiple integers of 1 ms. ms0 corresponds to 0, ms1
corresponds to 1 ms, ms2 corresponds to 2 ms, and so on.
drx-LongCycleStartOffsetPTM
drx-LongCycle-PTM in ms and drx-StartOffset-PTM in multiples
of 1 ms.
drx-onDurationTimerPTM
Value in multiples of 1/32 ms (subMilliSeconds) or in ms
(milliSecond). For the latter, value ms1 corresponds to 1 ms,
value ms2 corresponds to 2 ms, and so on.
drx-RetransmissionTimer-DL-PTM
Value in number of slot lengths of the CFR where the transport
block was received. value sl0 corresponds to 0 slots, sl1
corresponds to 1 slot, sl2 corresponds to 2 slots, and so on.
drx-SlotOffsetPTM
Value in 1/32 ms. Value 0 corresponds to 0 ms, value 1 corresponds
to 1/32 ms, value 2 corresponds to 2/32 ms, and so on.

| Conditional | |
|---|---|
| Presence | Explanation |
| HARQFeedback | The field is mandatory present if HARQ feedback |
| | is enabled for a G-RNTI/G-CS-RNTI associated |
| | with the DRX configuration and UE is in |
| | RRC_CONNECTED. It is absent otherwise. |

In an embodiment, the DRX configuration that is utilized for multicast reception in the RRC_INACTIVE state can be at least one of configuration which the UE (100) has stored previously (e.g., from RRC reconfiguration message) or is the configuration stored in the UE inactive AS context or is provided to the UE (100) by the RRC Release with suspend config (e.g., multicast-InactiveConfig for the multicast MRB(s) in the suspendconfig for multicast reception in RRC_INACTIVE like). In an embodiment, the DRX configuration that is utilized for the multicast reception in the RRC_INACTIVE state can be at least one of configuration which the UE (100) has received from the multicast MCCH message. This also implies the latest DRX configuration as received in the most recent multicast MCCH message is utilized by the UE (100). Further, the UE (100) may store the configuration in the UE inactive AS context.

In an embodiment, the DRX configuration for the multicast MRB(s) for the multicast reception in the RRC_INACTIVE is released from the UE (100) inactive context when the UE (100) initiates a RRC connection resumption procedure.

In an embodiment, the DRX configuration for the multicast MRB(s) for the multicast reception in the RRC_INACTIVE is released when the UE (100) initiates a RRC reestablishment procedure.

In an embodiment, the DRX configuration for the multicast MRB(s) for the multicast reception in the RRC_INACTIVE is released when the UE (100) performs a cell reselection.

In an embodiment, the DRX configuration for the multicast MRB(s) for the multicast reception in the RRC_INACTIVE is released when the UE (100) performs the cell reselection to a different cell than the cell that configured the DRX configuration.

In an embodiment, the DRX configuration for multicast MRB(s) for multicast reception in the RRC_INACTIVE is released when the UE (100) performs the cell reselection to a different cell that is outside the coverage of the multicast service. That is, the same DRX configuration may be applied to receive multicast session in the RRC_INACTIVE as long as the UE (100) remains in the cell or cells that are part of the multicast service coverage area.

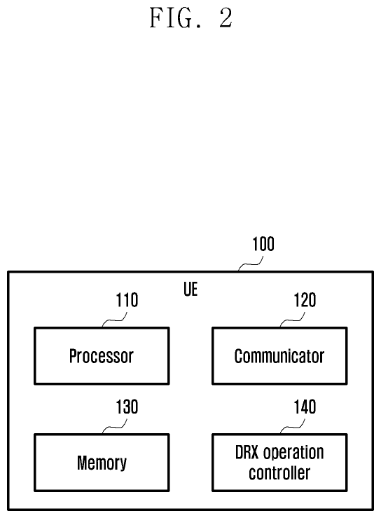

FIG. 2 shows various hardware components of the UE (100), according to the embodiments as disclosed herein. In an embodiment, the UE (100) includes a processor (110), a communicator (120), a memory (130) and a DRX operation controller (140). The processor (110) is coupled with the communicator (120), the memory (130) and the DRX operation controller (140).

The DRX operation controller (140) receives the DRX configuration for the MRB for the multicast session reception to be received in the RRC inactive state. Further, the DRX operation controller (140) detects the event, where the UE (100) is in the RRC inactive state.

The event corresponds at least one of: not enabling or allowing the UE (100) to receive retransmission for the multicast service packet reception, the UE (100) transitions from the RRC connected state to the RRC inactive state when the multicast session is in the activated state and the multicast DRX is configured, the UE (100) transitions from the RRC connected state to the RRC inactive state when the multicast session is in the deactivated state and the multicast DRX is configured, the UE (100) transitions from the RRC connected state to the RRC inactive state, the UE (100) is in the RRC inactive state and the multicast session is activated, while at least one of the drx-onDurationTimerPTM and the drx-InactivityTimerPTM for at least one of the G-RNTI and the G-CS-RNTI is running, when the multicast session for the TMGI is configured, and the multicast session is activated upon the group notification reception, the multicast session for the TMGI is configured, and the multicast session is not in the activated state, the multicast session for the TMGI that is configured, and the multicast session is in the activated state, retransmission for the multicast service packet when the UE (100) is receiving the multicast session in the RRC inactive state, the UE (100) receiving the multicast session reception in the RRC inactive state and does not provide HARQ feedback for the MBS MAC PDU, and the UE (100) is receiving the multicast session in the RRC inactive state.

Upon detecting the event, the DRX operation controller (140) handles the DRX operation for the multicast session reception in the RRC inactive state in the wireless network (1000).

In an embodiment, the DRX operation controller (140) stops at least one of the drx-Retransmission TimerDL-PTM and the drx-HARQ-RTT-TimerDL-PTM in the RRC inactive state upon detecting the event corresponds to not enabling or allowing the UE (100) to receive retransmission for the multicast service packet reception.

In an embodiment, the DRX operation controller (140) continues at least one of the drx-onDurationTimerPTM and the drx-InactivityTimerPTM timer upon detecting that the UE (100) transitions from the RRC connected state to the RRC inactive state when the multicast session is in the activated state and the multicast DRX is configured.

In an embodiment, the DRX operation controller (140) stops at least one of the drx-onDurationTimerPTM and the drx-Inactivity TimerPTM timer, upon detecting that the UE (100) transitions from the RRC connected state to the RRC inactive state when the multicast session is in the deactivated state and the multicast DRX is configured.

In an embodiment, the DRX operation controller (140) stops at least one of the drx-RetransmissionTimerDL-PTM and the drx-HARQ-RTT-TimerDL-PTM upon detecting the UE (100) transitions from the RRC connected state to the RRC inactive state.

In an embodiment, the DRX operation controller (140) determines the Active Time for the multicast DRX in the RRC inactive state, when the multicast DRX is configured for at least one of the G-RNTI and the G-CS-RNTI, when the UE (100) is in the RRC inactive state and multicast session is activated, while at least one of the drx-onDurationTimerPTM and the drx-InactivityTimerPTM for at least one of the G-RNTI and the G-CS-RNTI is running.

In an embodiment, the DRX operation controller (140) stops at least one configured DRX timer, when the multicast session for the TMGI is configured, and the multicast session is not in an activated state.

In an embodiment, the DRX operation controller (140) starts the at least one configured DRX timer, when the multicast session for the TMGI is configured, and the multicast session is activated upon the group notification reception, where the group notification reception is provided by the group paging message or the multicast MCCH message. Further, the DRX operation controller (140) applies the DRX configuration.

In an embodiment, the DRX operation controller (140) operates at least one configured DRX timer, when the multicast session for the TMGI is configured, and the multicast session is in the activated state. Further, the DRX operation controller (140) stops the at least one configured DRX timer, when the multicast session for the TMGI is configured, and the multicast session is deactivated upon the group notification reception, where the group notification reception is provided by the group paging message or the multicast MCCH message. Further, the DRX operation controller (140) stores the DRX configuration.

In an embodiment, the DRX operation controller (140) operates at least one configured DRX timer, when the multicast session for the TMGI that is configured and the multicast session is in the activated state. Further, the DRX operation controller (140) stops the at least one configured DRX timer, when the multicast session for the TMGI that is configured and the multicast session is released upon the group notification reception, where the group notification reception is provided by the group paging message or the multicast MCCH message. Further, the DRX operation controller (140) releases the DRX configuration.

In an embodiment, the multicast session in the activated state is notified using at least one of the group paging, the broadcast signaling (e.g., SIB, multicast MCCH message or the like) and the multicast MCCH change notification.

In an embodiment, the DRX operation controller (140) operates at least one of the drx-RetransmissionTimerDL-PTM and the drx-HARQ-RTT-TimerDL-PTM upon receiving the retransmission for the multicast service packet when the UE (100) is receiving the multicast session reception in the RRC inactive state.

In an embodiment, the DRX operation controller (140) considers the HARQ feedback condition as invalid, upon determining that UE (100) is receiving the multicast session in the RRC inactive state and does not provide HARQ feedback for the MBS MAC PDU.

In an embodiment, the DRX operation controller (140) ignores the DCI field that indicates the “HARQfeedback” as enabled or disabled value, upon determining that the UE (100) is receiving the multicast session in the RRC inactive state.

In an embodiment, the DRX operation controller (140) considers at least one of the drx-RetransmissionTimerDL-PTM and the drx-HARQ-RTT-TimerDL-PTM in the configuration as invalid in the RRC inactive state.

In an embodiment, the DRX operation controller (140) removes the drx-RetransmissionTimerDL-PTM and the drx-HARQ-RTT-TimerDL-PTM from the DRX configuration upon detecting that the UE (100) transitions from the RRC connected state to the RRC inactive state.

Further, the DRX operation controller (140) releases the DRX configuration for the multicast MBS radio bearer for the multicast session reception in the RRC inactive state.

In an embodiment, the DRX configuration for the multicast MRB for the multicast session reception in the RRC inactive state is released when the UE (100) initiates at least one of the RRC connection resumption procedure and the RRC reestablishment procedure.

In another embodiment, the DRX configuration for the multicast MRB for the multicast session reception in the RRC inactive state is released when the UE (100) performs at least one of the cell reselection, the cell reselection to the different cell than a cell that configured the DRX configuration, and the cell reselection to a different cell that is outside a coverage of the multicast service reception in the RRC inactive state.

In another embodiment, the DRX configuration used for the multicast session reception in the RRC inactive state is at least one of configuration which the UE (100) has stored previously or is a configuration stored in the UE inactive AS context or is provided to the UE (100) by the RRC Release with suspend configuration message or a multicast MCCH message.

The DRX operation controller (140) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

Although the FIG. 2 shows various hardware components of the UE (100) but it is to be understood that other embodiments are not limited thereon. In other embodiments, the UE (100) may include less or more number of components. Further, the labels or names of the components are used only for illustrative purpose and does not limit the scope of the invention. One or more components can be combined together to perform same or substantially similar function in the UE (100).

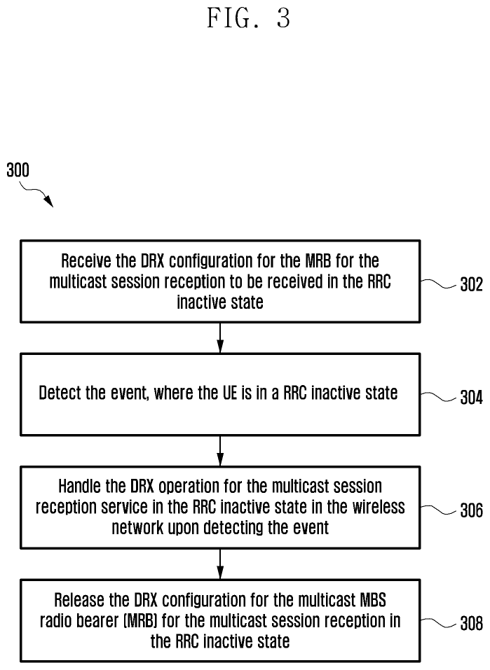

FIG. 3 is a flow chart (300) illustrating a method, implemented by the UE (100), for handling the DRX operation for the MBS multicast reception in the wireless network (1000), according to the embodiments as disclosed herein. The operations (302-308) are handled by the DRX operation controller (140).

At step 302, the method includes receiving the DRX configuration for the MRB for the multicast session reception to be received in the RRC inactive state. At step 304, the method includes detecting the event, where the UE (100) is in the RRC inactive state. At step 306, the method includes handling the DRX operation for the multicast session reception in the RRC inactive state in the wireless network (1000) upon detecting the event. At step 308, the method includes releasing the DRX configuration for the multicast MBS radio bearer (MRB) for the multicast session reception in the RRC inactive state.

The method can be used to receive the multicast services in the RRC_INACTIVE state in an efficient, a reliable and robust manner.

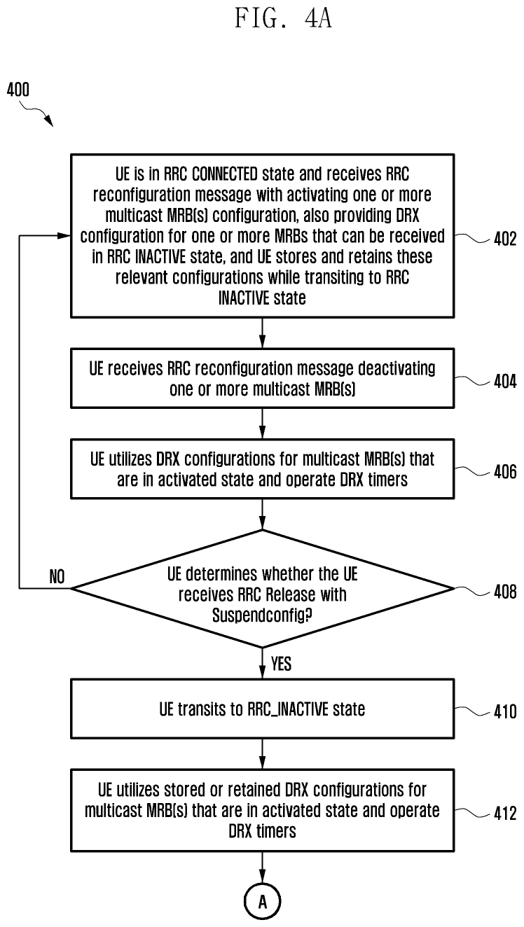

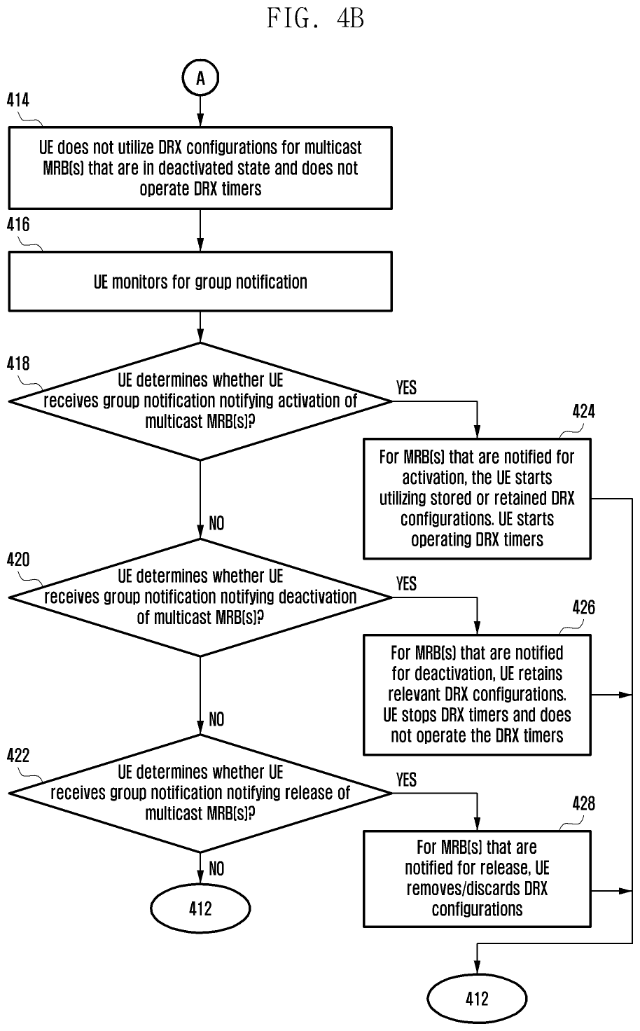

FIG. 4A and FIG. 4B illustrate an operational flow chart (400) of the DRX operation for the UE (100) configured and/or receiving multicast in the RRC_INACTIVE state, according to embodiments as disclosed herein.

At step 402, the UE (100) is in the RRC CONNECTED state and receives the RRC reconfiguration message with activating the one or more multicast MRB(s) configuration. The UE (100) provides the DRX configuration for the one or more MRBs that can be received in the RRC INACTIVE state. The UE (100) stores and retains the relevant configurations while transiting to the RRC INACTIVE state.

At step 404, the UE (100) receives the RRC reconfiguration message deactivating the one or more multicast MRB(s). At step 406, the UE (100) utilizes the DRX configurations for the multicast MRB(s) that are in the activated state and operates the DRX timers.

At step 408, the UE (100) determines whether the UE (100) receives the RRC Release with Suspendconfig? In response to determining that the UE (100) does not receive the RRC Release with Suspendconfig then, at step 402, the UE (100) is in the RRC CONNECTED state.

In response to determining that the UE receives the RRC Release with Suspendconfig then, at step 410, the UE (100) transits to the RRC_INACTIVE state. At step 412, the UE (100) utilizes the stored or retained DRX configurations for the multicast MRB(s) that are in the activated state and operates the DRX timers.

At step 414, the UE (100) does not utilize DRX configurations for the multicast MRB(s) that are in the deactivated state and does not operate the DRX timers. At step 416, the UE (100) monitors for the group notification (e.g. group paging or multicast MCCH message).

At step 418, the UE (100) determines whether the UE (100) receives the group notification (e.g. group paging or multicast MCCH message) notifying activation of the multicast MRB(s). In response to determining that the UE (100) receives the group notification notifying activation of the multicast MRB(s) then, at step 424, for MRB(s) that are notified for activation, the UE (100) starts the utilizing stored or retained DRX configurations. The UE (100) starts operating the DRX timers.

In response to determining that the UE (100) does not receive the group notification notifying activation of the multicast MRB(s) then, at step 420, the UE (100) determines whether the UE (100) receives the group notification notifying deactivation of the multicast MRB(s).

In response to determining that the UE (100) does not receive the group notification notifying deactivation of the multicast MRB(s) then, at step 422, the UE (100) determines whether the UE (100) receives the group notification notifying release of multicast MRB(s)?

In response to determining that the UE (100) receives the group notification (e.g. group paging or multicast MCCH message) notifying deactivation of the multicast MRB(s) then, at step 426, for MRB(s) that are notified for deactivation, the UE (100) retains the relevant DRX configurations. The UE (100) stops the DRX timers and does not operate the DRX timers.

In response to determining that the UE (100) receives the group notification (e.g. group paging or multicast MCCH message) notifying release of multicast MRB(s) then, at step 428, for MRB(s) that are notified for release, the UE (100) removes/discards the DRX configurations. In response to determining that the UE (100) does not receive the group notification notifying release of multicast MRB(s) then, at step 412, the UE utilizes the stored or retained DRX configurations for the multicast MRB(s) that are in the activated state and operates the DRX timers.

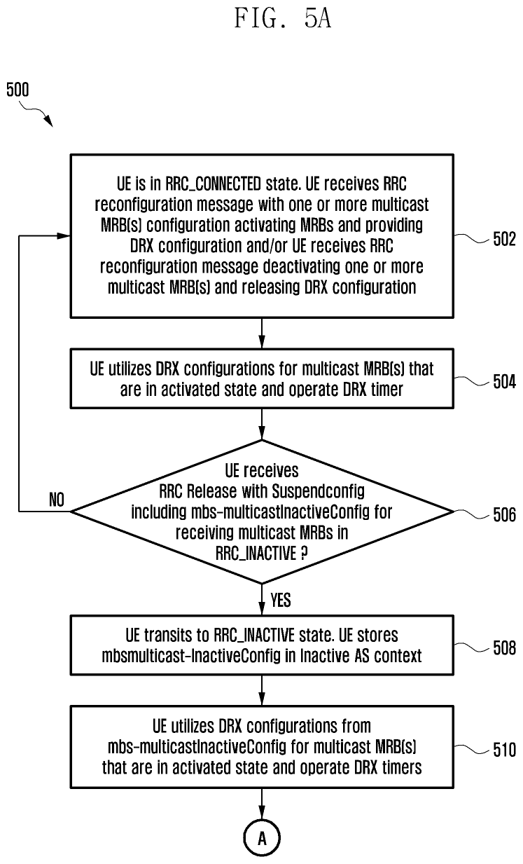

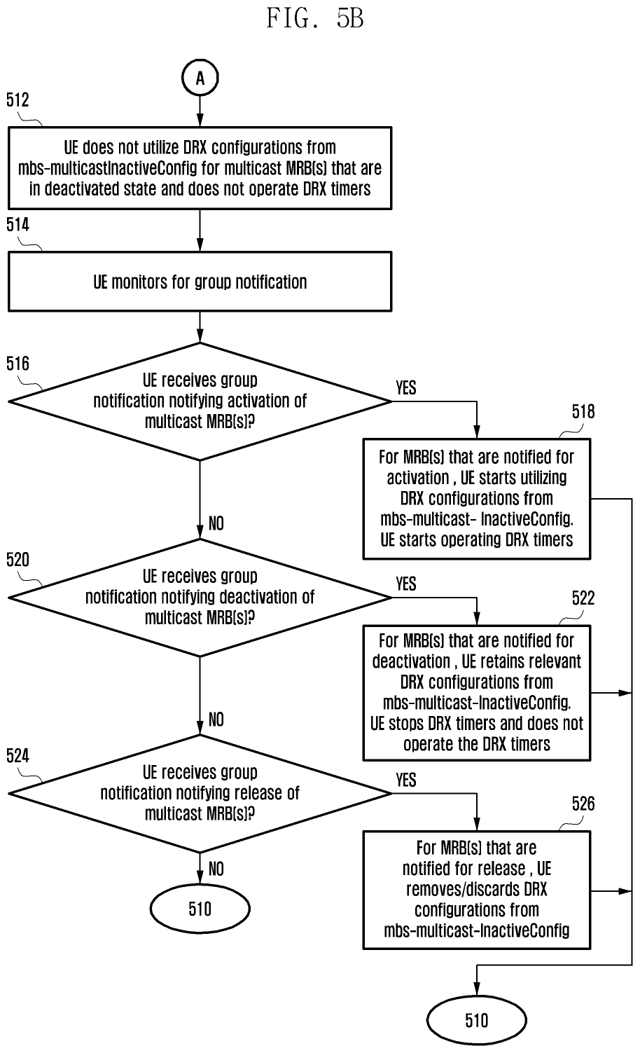

FIG. 5A and FIG. 5B illustrate an operational flow diagram (500) of the DRX operation for the UE (100) configured and/or receiving multicast in RRC_INACTIVE state, according to embodiments as disclosed herein.

At step 502, the UE (100) is in the RRC connected state. The UE (100) receives the RRC reconfiguration message with the one or more multicast MRB(s) configuration activating the MRBs and provides the DRX configuration and/or the UE (100) receives the RRC reconfiguration message deactivating the one or more multicast MRB(s) and releases the DRX configuration. At step 504, the UE (100) utilizes the DRX configurations for the multicast MRB(s) that are in the activated state and operates the DRX timer. At step 506, the UE (100) determines whether the UE (100) receives the RRC release with the Suspendconfig including mbs-multicastInactiveConfig for receiving the multicast MRBs in the RRC_INACTIVE?

In response to determining that the UE (100) does not receive the RRC release with the Suspendconfig including mbs-multicastInactiveConfig for receiving the multicast MRBs in the RRC_INACTIVE then, at step 502, the UE (100) is in the RRC connected state. The UE (100) receives the RRC reconfiguration message with the one or more multicast MRB(s) configuration activating MRBs and providing the DRX configuration and/or the UE (100) receives the RRC reconfiguration message deactivating one or more multicast MRB(s) and releases the DRX configuration.

In response to determining that the UE (100) receives the RRC release with the Suspendconfig including mbs-multicastInactiveConfig for receiving the multicast MRBs in the RRC_INACTIVE then, at step 508, the UE (100) transits to the RRC_INACTIVE state. The UE (100) stores the mbsmulticast-InactiveConfig in the inactive AS context.

At step 510, the UE (100) utilizes the DRX configurations from the mbs-multicastInactiveConfig for the multicast MRB(s) that are in the activated state and operates the DRX timers. At step 512, the UE (100) does not utilize the DRX configurations from mbs-multicastInactiveConfig for the multicast MRB(s) that are in the deactivated state and does not operate the DRX timers. At step 514, the UE (100) monitors for the group notification (e.g. group paging or multicast MCCH message).

At step 516, the UE (100) determines whether the UE (100) receives the group notification (e.g. group paging or multicast MCCH message) notifying activation of the multicast MRB(s)? In response to determining that the UE (100) receives the group notification notifying activation of the multicast MRB(s), at step 518, for the MRB(s) that are notified for activation, the UE (100) starts the utilizing DRX configurations from the mbs-multicast-InactiveConfig. The UE (100) starts the operating DRX timers.

In response to determining that the UE (100) does not receive the group notification notifying activation of the multicast MRB(s), at step 520, the UE (100) determines whether the UE (100) receives the group notification notifying deactivation of multicast MRB(s)? in response to determining the UE (100) receives the group notification (e.g. group paging or multicast MCCH message) notifying deactivation of multicast MRB(s) then, at step 522, for MRB(s) that are notified for deactivation, the UE (100) retains the relevant DRX configurations from the mbs-multicast-InactiveConfig. The UE (100) stops the DRX timers and does not operate the DRX timers.

In response to determining the UE (100) does not receive the group notification notifying deactivation of multicast MRB(s) then, at step 524, the UE (100) determines whether the UE (100) receives the group notification notifying release of the multicast MRB(s)?

In response to determining that the UE (100) receives the group notification (e.g. group paging or multicast MCCH message) notifying release of the multicast MRB(s) then, at step 526, for MRB(s) that are notified for release, the UE (100) removes/discards the DRX configurations from the mbs-multicast-InactiveConfig. In response to determining that the UE (100) does not receive the group notification notifying release of the multicast MRB(s) then, at step 510, the UE (100) utilizes the DRX configurations from the mbs-multicastInactiveConfig for the multicast MRB(s) that are in the activated state and operates the DRX timers.

The UE (100) utilizes the DRX configurations from the mbs-multicastInactiveConfig for the multicast MRB(s) that are in the activated state and operates the DRX timers after the operations of 518, 522, and 526.

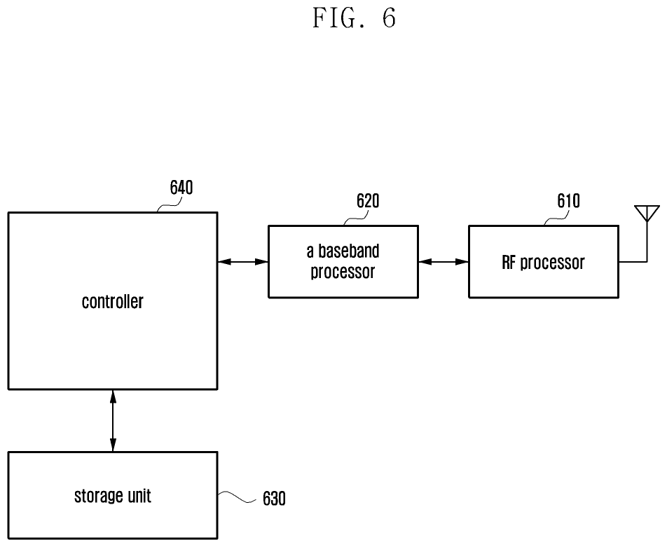

The structure of the UE to which embodiments of the disclosure can be applied is illustrated in FIG. 6.

Referring to FIG. 6, the UE includes a radio frequency (RF) processor 610, a baseband processor 620, a storage unit 630, and a controller 640.

The RF processor 610 performs a function for transmitting and receiving a signal through a wireless channel, such as band conversion and amplification of a signal. That is, the RF processor 610 up-converts a baseband signal provided from the baseband processor 620 into an RF band signal, transmits the RF band signal through an antenna, and then down-converts the RF band signal received through the antenna into a baseband signal. For example, the RF processor 610 may include a transmission filter, a reception filter, an amplifier, a mixer, an oscillator, a digital-to-analog converter (DAC), an analog-to-digital converter (ADC), and the like. Although FIG. 6 illustrates only one antenna, the UE may include a plurality of antennas. In addition, the RF processor 610 may include a plurality of RF chains. Moreover, the RF processor 610 may perform beamforming. For the beamforming, the RF processor 610 may control a phase and a size of each signal transmitted/received through a plurality of antennas or antenna elements. The RF processor may perform MIMO and receive a plurality of layers when performing the MIMO operation. The RF processor 610 may appropriately configure a plurality of antennas or antenna elements according to the control of the controller to perform reception beam sweeping or control a direction of a reception beam and a beam width so that the reception beam corresponds to a transmission beam.

The baseband processor 620 performs a function for a conversion between a baseband signal and a bitstream according to a physical layer standard of the system. For example, when data is transmitted, the baseband processor 620 generates complex symbols by encoding and modulating a transmission bitstream. Further, when data is received, the baseband processor 620 reconstructs a reception bitstream by demodulating and decoding a baseband signal provided from the RF processor 610. For example, in an orthogonal frequency division multiplexing (OFDM) scheme, when data is transmitted, the baseband processor 620 generates complex symbols by encoding and modulating a transmission bitstream, mapping the complex symbols to subcarriers, and then configures OFDM symbols through an inverse fast Fourier transform (IFFT) operation and a cyclic prefix (CP) insertion. Further, when data is received, the baseband processor 620 divides the baseband signal provided from the RF processor 610 in the unit of OFDM symbols, reconstructs the signals mapped to the subcarriers through a fast Fourier transform (FFT) operation, and then reconstructs a reception bitstream through demodulation and decoding.

The baseband processor 620 and the RF processor 610 transmit and receive signals as described above. Accordingly, the baseband processor 620 and the RF processor 610 may be referred to as a transmitter, a receiver, a transceiver, or a communication unit. Further, at least one of the baseband processor 620 and the RF processor 610 may include a plurality of communication modules to support a plurality of different radio access technologies. In addition, at least one of the baseband processor 620 and the RF processor 610 may include different communication modules to process signals of different frequency bands. For example, the different radio-access technologies may include an LTE network and an NR network. Further, the different frequency bands may include a super high frequency (SHF) (for example, 2.5 GHz and 5 Ghz) band and a millimeter (mm) wave (for example, 60 GHz) band.

The storage unit 630 stores data such as basic program, an application, and setting information for the operation of the UE. The storage unit 630 provides the stored data according to a request from the controller 640.

The controller 640 controls the overall operation of the UE. For example, the controller 640 transmits/receives a signal through the baseband processor 620 and the RF processor 610. In addition, the controller 640 may record data in the storage unit 630 and read the data. To this end, the controller 640 may include at least one processor. For example, the controller 640 may include a communication processor (CP) that performs a control for communication, and an application processor (AP) that controls a higher layer such as an application program.

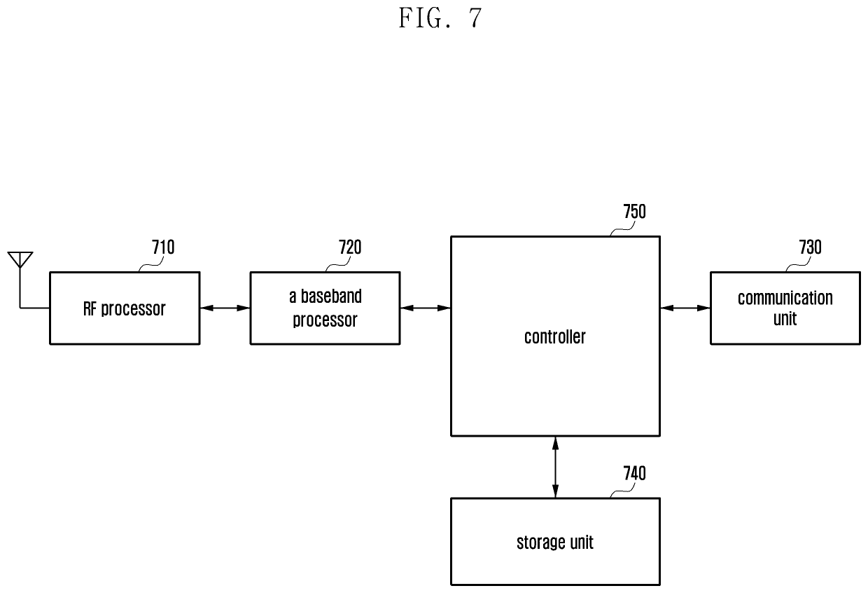

FIG. 7 illustrates a block diagram of a base station in a wireless communication system to which embodiments of the disclosure can be applied.

As illustrated in FIG. 7, the base station includes an RF processor 710, a baseband processor 720, a backhaul communication unit 730, a storage unit 740, and a controller 750.

The RF processor 710 performs a function for transmitting and receiving a signal through a wireless channel, such as band conversion and amplification of a signal. That is, the RF processor 710 up-converts a baseband signal provided from the baseband processing unit 720 into an RF band signal and then transmits the converted signal through an antenna, and down-converts an RF band signal received through the antenna into a baseband signal. For example, the RF processor 710 may include a transmission filter, a reception filter, an amplifier, a mixer, an oscillator, a DAC, and an ADC. Although FIG. 7 illustrates only one antenna, the first access node may include a plurality of antennas. In addition, the RF processor 710 may include a plurality of RF chains. Moreover, the RF processor 710 may perform beamforming. For the beamforming, the RF processor 710 may control a phase and a size of each of the signals transmitted and received through a plurality of antennas or antenna elements. The RF processor may perform a downlink MIMO operation by transmitting one or more layers.

The baseband processor 720 performs a function of performing conversion between a baseband signal and a bitstream according to a physical layer standard of the first radio access technology. For example, when data is transmitted, the baseband processor 720 generates complex symbols by encoding and modulating a transmission bitstream. Further, when data is received, the baseband processor 720 reconstructs a reception bitstream by demodulating and decoding a baseband signal provided from the RF processor 710. For example, in an OFDM scheme, when data is transmitted, the baseband processor 720 may generate complex symbols by encoding and modulating the transmission bitstream, map the complex symbols to subcarriers, and then configure OFDM symbols through an IFFT operation and CP insertion. In addition, when data is received, the baseband processor 720 divides a baseband signal provided from the RF processor 710 in units of OFDM symbols, recovers signals mapped with sub-carriers through an FFT operation, and then recovers a reception bitstream through demodulation and decoding. The baseband processor 720 and the RF processor 710 transmit and receive signals as described above. Accordingly, the baseband processor 720 and the RF processor 710 may be referred to as a transmitter, a receiver, a transceiver, or a communication unit.

The communication unit 730 provides an interface for communicating with other nodes within the network.

The storage unit 740 stores data such as a basic program, an application, and setting information for the operation of the MeNB. Particularly, the storage unit 740 may store information on bearers allocated to the accessed UE and the measurement result reported from the accessed UE. Further, the storage unit 740 may store information on a reference for determining whether to provide multiple connections to the UE or stop the multiple connections. In addition, the storage unit 740 provides data stored therein according to a request from the controller 750.

The controller 750 controls the overall operation of the MeNB. For example, the controller 750 transmits and receives a signal through the baseband processor 720 and the RF processor 710 or through the backhaul communication unit 730. In addition, the controller 750 may record data in the storage unit 740 and read the data. To this end, the controller 750 may include at least one processor.

Although the present disclosure has been described with various embodiments, various changes and modifications may be suggested to one skilled in the art. It is intended that the present disclosure encompass such changes and modifications as fall within the scope of the appended claims.

The various actions, acts, blocks, steps, or the like in the flow charts (300-500) may be performed in the order presented, in a different order or simultaneously. Further, in some embodiments, some of the actions, acts, blocks, steps, or the like may be omitted, added, modified, skipped, or the like without departing from the scope of the invention.

The embodiments disclosed herein can be implemented through at least one software program running on at least one hardware device and performing network management functions to control the elements. The elements can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the spirit and scope of the embodiments as described herein.

1-15. (canceled)

16. A method performed by a terminal supporting a discontinuous reception (DRX) operation in a wireless communication system, the method comprising:
receiving, from a base station, DRX configuration information for point to multi-point (PTM) transmission in a radio resource control (RRC) connected state, wherein the DRX configuration information for the PTM transmission is associated with a multicast and broadcast service (MBS) multicast in an RRC inactive state;
receiving, from the base station, an RRC release message with configuration for suspension;
transitioning from the RRC connected state to an RRC inactive state, as a response to the RRC release message to suspend the RRC connected state; and
monitoring a physical downlink control channel (PDCCH) in an active time in the RRC inactive state, based on the DRX configuration information for the PTM transmission,
wherein in case that the terminal supports a retransmission for the PTM, the active time includes a time while a DRX retransmission Timer for the PTM is running.

17. The method of claim 16, the method further comprising:
starting a DRX hybrid automatic repeat request (HARQ) round trip time (RTT) Timer for the PTM for a corresponding HARQ process, and
in case that the DRX HARQ RTT Timer for the PTM expires, starting the DRX retransmission Timer for the PTM for the corresponding HARQ process in a first symbol after the expiry of the DRX HARQ RTT Timer for the PTM.

18. The method of claim 16,
wherein in case that the terminal does not support a retransmission for the PTM in the RRC inactive state, the active time includes a time while at least one a DRX on Duration Timer for the PTM, or a DRX Inactivity Timer for the PTM is running.

19. The method of claim 16,
wherein the DRX configuration information further includes at least one first information on a DRX on Duration Timer for the PTM, second information on a DRX Inactivity Timer for the PTM, third information on the DRX retransmission Timer for the PTM, or fourth information on a DRX HARQ RTT Timer for the PTM.

20. The method of claim 16,
wherein the PDCCH is associated with a group radio network temporary identifier (G-RNTI).

21. The method of claim 16,
wherein in case that the terminal transits from the RRC connected state to the RRC inactive state, at least one a DRX on Duration Timer for the PTM or a DRX Inactivity Timer for the PTM is restarted.

22. The method of claim 16,
wherein in case that the terminal performs a cell reselection, the DRX configuration for the PTM transmission is released.

23. A method performed by a base station associated with a discontinuous reception (DRX) operation in a wireless communication system, the method comprising:
transmitting, to a terminal, DRX configuration information for point to multi-point (PTM) transmission, wherein the DRX configuration information for the PTM transmission is associated with a multicast and broadcast service (MBS) multicast in a radio resource control (RRC) inactive state;
transmitting, to the terminal, a RRC release message with configuration for suspension; and
transmitting, to the terminal, a physical downlink control channel (PDCCH),
wherein the PDCCH is monitored in an active time of the terminal which is in the RRC inactive state, and
wherein the active time is associated with a DRX retransmission Timer for the PTM.

24. The method of claim 23,
wherein the DRX configuration information further includes at least one first information on a DRX on Duration Timer for the PTM, second information on a DRX Inactivity Timer for the PTM, third information on the DRX retransmission Timer for the PTM, or fourth information on a DRX HARQ RTT Timer for the PTM, and
wherein the PDCCH is associated with a group radio network temporary identifier (G-RNTI).

25. A terminal supporting a discontinuous reception (DRX) operation in a wireless communication system, the terminal comprising:
a transceiver; and
a controller coupled with the transceiver, and configured to:
receive, from a base station, DRX configuration information for point to multi-point (PTM) transmission in a radio resource control (RRC) connected state, wherein the DRX configuration information for the PTM transmission is associated with a multicast and broadcast service (MBS) multicast in an RRC inactive state,
receive, from the base station, an RRC release message with configuration for suspension,
transition from the RRC connected state to an RRC inactive state, as a response to the RRC release message to suspend the RRC connected state, and
monitor a physical downlink control channel (PDCCH) in an active time in the RRC inactive state, based on the DRX configuration information for the PTM transmission,
wherein in case that the terminal supports a retransmission for the PTM, the active time includes a time while a DRX retransmission Timer for the PTM is running.

26. The terminal of claim 25, the controller is further configured to:
start a DRX hybrid automatic repeat request (HARQ) round trip time (RTT) Timer for the PTM for a corresponding HARQ process, and
in case that the DRX HARQ RTT Timer for the PTM expires, start the DRX retransmission Timer for the PTM for the corresponding HARQ process in a first symbol after the expiry of the DRX HARQ RTT Timer for the PTM.

27. The terminal of claim 25,
wherein in case that the terminal does not support a retransmission for the PTM in the RRC inactive state, the active time includes a time while at least one a DRX on Duration Timer for the PTM, or a DRX Inactivity Timer for the PTM is running.

28. The terminal of claim 25,
wherein the DRX configuration information further includes at least one first information on a DRX on Duration Timer for the PTM, second information on a DRX Inactivity Timer for the PTM, third information on the DRX retransmission Timer for the PTM, or fourth information on a DRX HARQ RTT Timer for the PTM.

29. The terminal of claim 25,
wherein the PDCCH is associated with a group radio network temporary identifier (G-RNTI).

30. The terminal of claim 25,
wherein in case that the terminal transits from the RRC connected state to the RRC inactive state, at least one a DRX on Duration Timer for the PTM or a DRX Inactivity Timer for the PTM is restarted.

31. The terminal of claim 25,
wherein in case that the terminal performs a cell reselection, the DRX configuration for the PTM transmission is released.

32. A base station associated with a discontinuous reception (DRX) operation in a wireless communication system, the base station comprising:
a transceiver; and
a controller coupled with the transceiver, and configured to:
transmit, to a terminal, DRX configuration information for point to multi-point (PTM) transmission, wherein the DRX configuration information for the PTM transmission is associated with a multicast and broadcast service (MBS) multicast in a radio resource control (RRC) inactive state,
transmit, to the terminal, a RRC release message with configuration for suspension, and
transmit, to the terminal, a physical downlink control channel (PDCCH),
wherein the PDCCH is monitored in an active time of the terminal which is in the RRC inactive state, and
wherein the active time is associated with a DRX retransmission Timer for the PTM.

33. The base station of claim 32,
wherein the DRX configuration information further includes at least one first information on a DRX on Duration Timer for the PTM, second information on a DRX Inactivity Timer for the PTM, third information on the DRX retransmission Timer for the PTM, or fourth information on a DRX HARQ RTT Timer for the PTM, and
wherein the PDCCH is associated with a group radio network temporary identifier (G-RNTI).
